(19) United States
(12) Patent Application Publication
(10) Pub. No.: US 2019/0050888 A1
(43) Pub. Date: Feb. 14, 2019

(54) Point Value Exchange System

(71) Applicant: American Express Travel Related Services Company, Inc., New York, NY (US)

(72) Inventors: David J. Elder, Ft. Lauderdale, FL (US); David B. Kennedy, Weston, FL (US); Mitchell Kurman, Coral Springs, FL (US); Jules Mahabir, Pembroke Pines, FL (US)

(73) Assignee: American Express Travel Related Services Company, Inc., New York, NY (US)

(21) Appl. No.: 15/674,315

(22) Filed: Aug. 10, 2017

(51) Int. Cl. G06Q 30/02; G06Q 20/12

(52) U.S. Cl. CPC G06Q 30/0227; G06Q 20/12

(57) ABSTRACT

The system may be configured to perform operations including determining a point conversion rate between a first merchant point value associated with a first merchant point and a second merchant point value associated with a second merchant point; receiving a request from a consumer to sell an exchanged point amount comprising a first merchant point amount; receiving a first payment from the first merchant for the first merchant point amount; retrieving the first merchant point amount from a consumer profile; transmitting the first merchant point amount to the first merchant; calculating a second merchant point amount equal to the first merchant point amount, based the first conversion rate; transmitting a second payment to the second merchant to purchase the second merchant point amount from the second merchant; receiving the second merchant point amount from the second merchant; and transmitting the second merchant point amount to the consumer profile.

### FIELD

The present disclosure generally relates to exchanging point values between merchants.

### BACKGROUND

Many merchants have points which the merchant may issue to a consumer or employee. The merchant points may have value associated with the merchant points, as determined by the merchant. Therefore, the consumer or employee in possession of the merchant points may redeem her points for rewards such as cash, products, gift cards, or the like. However, the points issued by a merchant may only be redeemable by that merchant, or another merchant with which the issuing merchant has partnered.

### SUMMARY

A system, method, and article of manufacture (collectively, “the system”) are disclosed relating to exchanging merchant points. In various embodiments, the system may be configured to perform operations including determining, by a processor, a point conversion rate between a first merchant point value associated with a first merchant point and a second merchant point value associated with a second merchant point, wherein the first merchant point is redeemable with a first merchant, and the second merchant point is redeemable with a second merchant; receiving, by the processor, a request from a consumer to sell an exchanged point amount, wherein the exchanged point amount comprises a first merchant point amount, wherein the first merchant point amount comprises at least one first merchant point; receiving, by the processor, a first payment from the first merchant for the first merchant point amount; retrieving, by the processor, the first merchant point amount from a consumer profile; transmitting, by the processor, the first merchant point amount to the first merchant; calculating, by the processor, a second merchant point amount, wherein the second merchant point amount comprises the second merchant point, equal to the first merchant point amount based the first conversion rate; transmitting, by the processor, a second payment to the second merchant to purchase the second merchant point amount from the second merchant; receiving, by the processor, the second merchant point amount from the second merchant; and/or transmitting, by the processor, the second merchant point amount to the consumer profile.

In various embodiments, the determining the point conversion rate may comprise determining, by the processor, a first standard conversion rate between the first merchant point value and a standard point value associated with a standard point; and/or calculating, by the processor, a second standard conversion rate between the second merchant point value and the standard point value. In various embodiments, the converting the first merchant point amount to the second merchant point amount may comprise converting, by the processor, the first merchant point amount to a first standard point amount comprising the standard point based on the first standard conversion rate, wherein the first standard point amount is comprised in an exchanged standard point amount; and/or converting, by the processor, the exchanged standard point amount to the second merchant point amount based on the second standard conversion rate.

In various embodiments, the operations may further comprise determining, by the processor, a first cash value associated with the first merchant point; and/or calculating, by the processor, the first payment for the first merchant point amount based on the first cash value. In various embodiments, the operations may further comprise determining, by the processor, a third standard conversion rate between a third merchant point value associated with a third merchant point and the standard point value, wherein the third merchant point is redeemable with a third merchant, wherein the exchanged point amount comprises a third merchant point amount comprising the third merchant point; receiving, by the processor, a third payment from the third merchant for the third merchant point amount; retrieving, by the processor, the third merchant point amount from the consumer profile; transmitting, by the processor, the third merchant point amount to the third merchant; and/or converting, by the processor, the third merchant point amount to a third standard point amount comprising the standard point, wherein the third standard point amount is comprised in the exchanged standard point amount. In various embodiments, the operations may further comprise adjusting, by the processor, at least one of the point conversion rate or the first standard conversion rate based on a change in at least one of the demand for the first merchant point, the first merchant point currency value, the public rating of the first merchant, or the public following. In various embodiments, the operations may further comprise displaying, by the processor, an offer to the consumer to exchange the first merchant point amount for the second merchant point amount. In various embodiments, at least one of the point conversion rate or the first standard conversion rate is based off of at least one of a demand for the first merchant point, a first merchant point currency value reflected by a currency conversion rate between the first merchant point value and a national currency, a public rating of the first merchant, or a public following.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 shows an exemplary point value exchange system, in accordance with various embodiments;

FIG. 2 shows a flowchart depicting an exemplary method for exchanging merchant points, in accordance with various embodiments;

FIG. 3 shows a flowchart depicting an exemplary method for exchanging more than two types of merchant points, in accordance with various embodiments; and

FIG. 4 shows a flowchart depicting an exemplary method for scoring items, such as merchant offers, in accordance with various embodiments.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

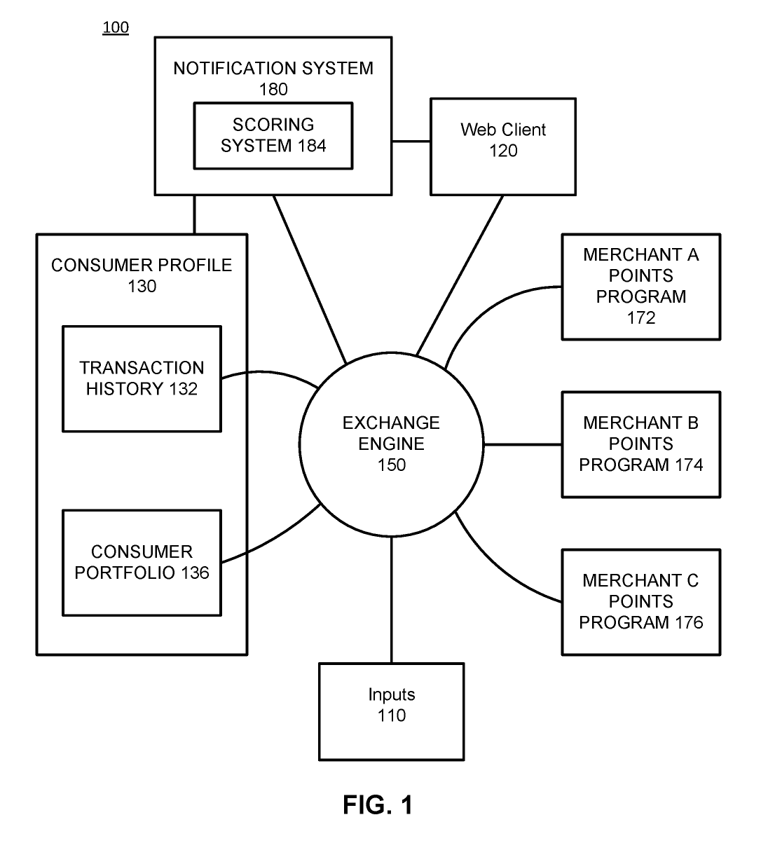

With reference to FIG. 1, in accordance with various embodiments, an exemplary point value exchange system 100 may comprise a web client 120, a consumer profile 130, an exchange engine 150, which may receive inputs 110, a notification system 180, and a merchant points program (e.g., merchant A points program 172, merchant B points program 174, and/or merchant C points program 176). In various embodiments, any or all of the components of system 100 may be in electronic communication with one another. System 100, in operation, may have the capability to exchange the points from consumer profile 130 from one or more merchants for the points of another merchant. Therefore, a consumer may make use of system 100 to obtain merchant points that are of the most value to the consumer. For example, a consumer may earn many points from merchant A, but the items offered by merchant B may be more desirable to the consumer. Therefore, the consumer may utilize system 100 to exchange the merchant A points for merchant B points. Additionally, in various embodiments, system 100 may have the capability to transfer merchant points between consumers, or allow the purchase or sale of merchant points in exchange for national currency (i.e., cash). System 100 may be computer-based, and may comprise a processor, a tangible non-transitory computer-readable memory, and/or a network interface. Instructions stored on the tangible non-transitory memory may allow system 100 to perform various functions, as described herein.

System 100 may not only allow consumers to better utilize merchant points by allowing them to obtain the merchant points that provide the most utility, but system 100 also allows merchants to be able to better account for their liabilities. For example, if merchant A has outstanding merchant A points with a consumer, but the consumer is not planning on using merchant A points, merchant A may have an outstanding liability that may never be removed from its accounting books. Also, those merchant A points issued to the consumer are worthless to the consumer. System 100 may allow, for example, the consumer to exchange the merchant A points for merchant B points, therefore adding value to the consumer, and allowing merchant A to purchase its outstanding liability (the merchant A points) to clear the liability from its accounting books.

In various embodiments, consumer profile 130 may belong and/or be associated with a consumer, and may comprise any information or data about the consumer that describes an attribute associated with the consumer (e.g., a preference, an interest, demographic information, personally identifying information, and/or the like). Consumer profile 130 may comprise a server appliance running a suitable server operating system (e.g., MICROSOFT INTERNET INFORMATION SERVICES or, “IIS”) and having database software (e.g., ORACLE) installed thereon. In various embodiments, consumer profile 130 may be based upon a variety of data. For example, consumer profile 130 may be based upon data that is received, culled, collected, and/or derived from a variety of sources, such as a consumer's transaction history, data associated with or available via a consumer's social networking profile (e.g., a consumer's FACEBOOK profile), web browsing data, data associated with a consumer's physical location, and/or other publicly and/or privately available sources of information about a consumer. In various embodiments, consumer profile 130 may not be based upon such data, unless a consumer opts in or requests that such data be used.

Further, in various embodiments, consumer profile 130 may be based upon data contributed by a consumer, a merchant, a third party, and/or a service establishment (SE), as described herein. Such data may comprise, for example, a consumer's personal information, e.g., demographic information, a consumer's date of birth, a consumer's residence information, an address of the consumer's work, a specific preference associated with the consumer (e.g., a preference for a certain type of vacation, such as a preference for a tropical vacation), a website in which the consumer is interested, and/or the like. Further, a consumer may contribute data towards a consumer profile by way of a form and/or questionnaire, such as, for example, a web-based form or questionnaire.

In various embodiments, consumer profile 130 may comprise a transaction history 132 associated with the consumer. Consumer transaction history 132 may comprise a history of the consumer's purchases from a merchant or multiple merchants, including information regarding product types, timing of purchases (e.g., a certain product types are purchased during summer, weekly grocery purchases, and/or the like), frequency of purchases, monetary amounts, geographic locations of purchases, frequency of purchases using merchant points, number of merchant points used with respective merchants, products purchased using merchant points, etc.

In various embodiments, consumer profile 130 may comprise a consumer portfolio 136, which may comprise the merchant points earned by the consumer from various merchants (e.g., by conducting transactions with such merchants). For example, consumer portfolio 136 may comprise merchant points from merchant A, merchant B, and/or merchant C. In various embodiments, consumer profile 130 may be able to store merchant points from merchants with which consumer has a merchant point profile.

In various embodiments, exchange engine 150 may be an engine by which an exchange rate between different merchant points is determined. Exchange engine 150 may comprise a server appliance running a suitable server operating system (e.g., MICROSOFT INTERNET INFORMATION SERVICES or, “IIS”) and having database software (e.g., ORACLE) installed thereon. In various embodiments, exchange engine 150 may determine a point exchange rate between reward points of at least two merchants (e.g., an exchange rate between merchant A points and merchant B points). For example, a merchant A point may equivalent to $0.05, and a merchant B point may be equivalent to $0.10. Therefore, an exchange rate between merchant A points and merchant B points may be 1:2. In various embodiments, exchange engine 150 may determine a standard exchange rate between each merchant point and a standard point with an associated standard point value. The standard point may be a reward point unassociated with any particular merchant, but the standard point may have a value against which all other merchant points are compared to determine each merchant point's value. For example, merchant A points may have a standard conversion rate of 1.1 merchant A points (i.e., one standard point equals 1.1 merchant A points). The standard point value associated with the standard point may be determined based on the value of a national currency (e.g., the U.S. dollar). For example, one U.S. dollar may equal 100 standard points. Therefore, the standard conversion rate between the standard point and a merchant's point may change by the standard point value changing with the correlated national currency, and/or based on a change in the value of the merchant's points.

In various embodiments, to determine the value of a merchant's points to determine an exchange rate (e.g., relative to the value another merchant's points and/or the standard point), exchange engine 150 may receive inputs 110. Inputs 110 may comprise any factor that may affect the value of a merchant's points, such as demand for a merchant's points, merchant point value relative to a national currency (i.e., cash), a merchant's market value (e.g., stock prices or the like), a public rating or public opinion of the merchant, a public following of the merchant, or the like. The demand for a merchant's points may be determined by the number of transactions conducted by consumers with the merchant in which the consumers are rewarded points, the number of transactions conducted by consumers with the merchant in which the consumer redeems points, the number of points awarded, and/or the number of promotions involving merchant points offered by a merchant. For example, if exchange engine 150 detects that a large number of consumers are conducting transactions with merchant A (and using and/or receiving high numbers of merchant A points), exchange engine 150 may determine that the value of merchant A points should increase and/or be relatively high compared to other merchant points (especially if there is a lower supply of merchant A points than are demanded based on transaction trends). As another example, if merchant A offers many promotions involving receiving additional or more merchant A points than usual, or special offers for redeeming items, exchange engine 150 may determine that the value of merchant A points should decrease and/or be relatively low compared to other merchant points because merchant A may be trying to increase usage of merchant A points. In various embodiments, exchange engine 150 may detect and track the number of transactions facilitated by exchange engine 150, track the number of points from respective merchants gathered and used by consumer profile 130, and/or merchant point programs (e.g., merchant A-C points programs 172-176) may transmit information related to merchant promotions and/or transactions involving the respective merchant points to exchange engine 150, allowing exchange engine 150 to analyze and determine the relative value of each merchant's points. Therefore, in various embodiments, various inputs 110 may be transmitted to exchange engine 150 by consumer profile 130 and/or merchant points programs 172-176.

In various embodiments, the merchant point value relative to cash may be determined by various methods. A merchant may place a cash value per merchant point, such as $0.01 per point in case the consumer wishes to redeem merchant points for cash. In various embodiments, the merchant point value relative to cash may be based on the amount of merchant points required to purchase an item using the merchant points. For example, if 2,000 merchant A points are required to purchase a toaster, with a manufacturer's suggested retail price (MSRP) of $20, then exchange engine 150 may determine that one merchant A point is worth $0.01. On the other hand, 2,500 merchant B points may be required to purchase the same toaster, and therefore, exchange engine 150 may determine that one merchant B point is worth $0.008. Exchange engine 150 may also determine an exchange rate between the merchant points of two merchants by comparing the number of respective points required to receive the same item. Going along with the example involving a toaster above, exchange engine 150 may determine that there is an exchange rate of 1:0.8 between merchant A points and merchant B points based on the different number of points required to receive the same item. In various embodiments, exchange engine 150 may determine a cash value for merchant points based on comparing the number of merchant points required to obtain an item for multiple items, to create an average for a merchant point cash value. Similarly, to establish an exchange rate between merchant points from different merchants, exchange engine 150 may analyze the difference in the number of points required to redeem the multiple items that are available from all merchants being analyzed, to establish an average.

The public rating or public opinion of a merchant may be determined based on a number of factors. Exchange engine 150 may have access to social media networks (e.g., FACEBOOK®, FOURSQUARE®, TWITTER®, MYSPACE®, LINKEDIN®, and the like), and trends in such social media networks may indicate whether public opinion of a merchant is high or low (or rising or falling). In various embodiments, exchange engine 150 may be able to track the number of times a merchant appears in news and media, and then determine if such publicity is positive or negative. Exchange engine 150, likewise, may be capable of detecting aspects of news and media related to a merchant, such as topics reflecting positive and negative publicity (e.g., by scanning reactions to news and media postings looking for comments containing praise, criticism, disgust, or the like). For example, if an article of merchant A's corruption is being shared thousands of times on a social media network, exchange engine 150 determine that the value of merchant A points should decrease. Public opinion of a merchant may also be determined by a merchant's stock prices, revenue, changes in sales (e.g., a dramatic decrease may indicate a boycott), acquisition of or mergers with other companies, or the like. The public following of a merchant may also be determined by information gathered from social media networks and/or news sources. For example, for merchants having social media accounts, exchange engine 150 may observe the number of social media users following the merchant social media account, metadata tags (e.g., hashtags) belonging to a merchant used by consumers and the frequency of such use, merchant publicity (e.g., recognition, articles, awards, protests, etc.).

In various embodiments, exchange engine 150 may gather inputs 110 for valuing merchant points by being in electronic communication with consumer profile 130 (e.g., to monitor frequency of transactions and point accumulation between consumers and merchants to determine demand and/or value of merchant points), social media or news networks to monitor metatags or other indicators of public following or public opinion of a merchant, merchant points programs (e.g., merchant A-C points programs 172-176, respectively) to determine items offered for the redemption of merchant points, the value of such merchant points, promotions offered, and/or number of merchant points issued, market reports to receive stock prices, and/or the like. To determine an exchange rate for a merchant points (e.g., the standard exchange rate relative to the standard point, or an exchange rated between merchant points), exchange engine 150 may analyze any of the factors discussed above, or any number of pieces of information from any one of the factors (e.g., analyzing multiple items redeemable by two merchants to determine the relative value of the merchant points between the merchants). Merchant point values and exchange rates may be updated periodically at any suitable time interval (e.g., daily, weekly, or the like) by exchange engine 150.

In various embodiments, merchant point programs (e.g., merchant A points program 172, merchant B points program 174, and/or merchant C points program 176) may be in electronic communication with exchange engine 150. Merchant points programs may comprise a server appliance running a suitable server operating system (e.g., MICROSOFT INTERNET INFORMATION SERVICES or, “IIS”) and having database software (e.g., ORACLE) installed thereon. In various embodiments, each merchant point program may be associated with a respective merchant. A merchant's point program may reward consumers transacting with the merchant by issuing reward points and giving the consumers a certain number of reward points per transaction and/or per dollar amount paid to merchant. Merchant points earned by a consumer may be stored in a consumer account on the merchant points program, and/or in consumer portfolio 136 of consumer profile 130. Consumer portfolio 136 may store the points earned from multiple merchants. In various embodiments, merchant points earned by a consumer may be stored on exchange engine 150.

Exchange engine 150 may facilitate the exchange of merchant points from merchant points programs 172-176 by a consumer and/or between consumers. For example, a consumer may wish to exchange merchant A points from merchant A points program 172 for merchant B points from merchant B points program 174. Based on the conversion rate between merchant A points and merchant B points, the consumer may exchange merchant A points for merchant B points. For example, if the exchange rate between merchant A points and merchant B points is 0.85, 100 merchant A points will equate to 85 merchant B points. In various embodiments, the exchange of merchant A points for merchant B points may comprise converting merchant A points to standard points based on a merchant A standard point conversion rate, and then the resulting standard points to merchant B points based on a merchant B standard point conversion rate. Using the conversion to standard points may facilitate exchanging two or more merchants' points for a third merchant's points. For example, suppose the consumer associated with consumer profile 130 wanted to exchange merchant A points and merchant C points (from merchant C points program 176) for merchant B points. Exchange engine 150 may convert merchant A points to standard points based on the merchant A standard point conversion rate, and convert merchant C points to standard points based on a merchant C standard point conversion rate, and add the resulting standard points together. Subsequently, the total standard points resulting from merchant A points and merchant C points may be converted to merchant B points based on the merchant B standard point conversion rate. In various embodiments, merchant points from any number of merchants can be exchanged for merchant points from one or more different merchants.

In various embodiments, a consumer may transfer merchant points to another consumer and/or trade points with another consumer. For example, there may be consumer profile 130 associated with a first consumer, and another consumer profile (not pictured) associated with a second consumer in electronic communication with exchange engine 150. The first consumer may transfer merchant points from consumer profile 130 to the second consumer profile, or the two consumer profiles may exchange merchant points through exchange engine 150. If the merchant points exchanged are from different merchants, exchange engine 150 may apply the conversion rate between the merchant points and/or the standard points to complete the exchange.

In various embodiments, exchange engine 150 may allow consumers to purchase merchant points by exchanging cash or cash equivalents (e.g., gift cards) for merchant points. For example, a consumer may wish to purchase merchant A points for cash. Consumer portfolio 136 may receive or have cash value stored, which may be converted to merchant A points based on a conversion rate determined by exchange engine 150. In various embodiments, the cash value may be converted to standard points based on a standard conversion rate between cash and standard points, and subsequently, the standard points may be converted to merchant A points, for which merchant A accepts payment for issues to exchange engine 150 to transmit to consumer portfolio 136. In various embodiments, a consumer may exchange a cash equivalent, e.g., a gift card, for points through exchange engine 150. For example, a consumer, having a gift card from merchant A, may input a gift card identifier to cause the gift card value to be disposed in consumer portfolio 136. The consumer may not wish to use the gift card because the consumer may not prefer merchant A, merchant A may not have a desired product, or any other reason. Therefore, the consumer may request exchange engine 150 to exchange the gift card value for merchant B points. In response, exchange engine 150 may retrieve the gift card value from consumer portfolio 136, and merchant A may transmit funds to purchase the gift card value based on a conversion rate between the gift card value and merchant A points (which may comprise converting both to standard points). In response, merchant B points program 174 may accept payment transmitted from exchange engine 150 for merchant B points, which merchant B points program 174 may issue to exchange engine 150. Exchange engine 150 may transmit the merchant B points to consumer profile 130, completing the exchange.

In various embodiments, web client 120 may incorporate hardware and/or software components. For example, web client 120 may comprise a server appliance running a suitable server operating system (e.g., MICROSOFT INTERNET INFORMATION SERVICES or, “IIS”). Web client 120 may be any device that allows a user to communicate with a network (e.g., a personal computer, personal digital assistant (e.g., IPHONE®, BLACKBERRY®), tablet, cellular phone, kiosk, and/or the like). Web client 120 may be in electronic communication with consumer profile 130, exchange engine 150, merchant points programs 172-176, and/or notification system 180. Web client 120 may allow the consumer to interact with and/or utilize exchange engine 150 to request exchanges of one merchant's points for another merchant's points

Web client 120 includes any device (e.g., personal computer, mobile device, etc.) which communicates via any network, for example such as those discussed herein. In various embodiments, web client 120 may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with a server via network by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various embodiments, browser may be configured to display an electronic channel.

In various embodiments, system 100 may comprise notification system 180 to present offers to a consumer associated with consumer profile 130. Notification system 180 may incorporate hardware and/or software components. For example, notification system 180 may comprise a server appliance running a suitable server operating system (e.g., MICROSOFT INTERNET INFORMATION SERVICES or, “IIS”). Notification system 180 may be in electronic communication with consumer profile 130, web client 120, exchange engine 150, and/or merchant points programs 172-176.

In various embodiments, notification system 180 may comprise a scoring system 184. Scoring system 184 may comprise hardware and/or software capable of scoring an item or determining a relative value to a consumer of merchant reward points from one merchant relative to another merchant. In various embodiments, scoring system 184 may be in electronic communication with consumer profile 130, exchange engine 150, and/or merchant points programs 172-176. In various embodiments, scoring system 184 (comprising and implementing a collaborative scoring algorithm) may analyze transaction history 132 of consumer profile 130, and/or may use the analysis of transaction history 132 to determine a score for an item in merchant points programs 172-176, such as an offer. For example, merchant A may be offering a product or cash in exchange for a required amount of merchant A points. Scoring system 184 may determine a score for that offer by analyzing transaction history 132 and consumer portfolio 136, which may reflect the offer's relevance to the consumer associated with consumer profile 130. Scoring system 184 may look for a user's transaction habits in transaction history 132, such as the types of transactions, the types of products or services transacted for, merchant points used (i.e., the number of points and/or from which merchant), the locations of transactions, the times of the day, week, month, and/or year the transactions are made, and/or the like, and match that information with items the consumer or user may be interested in. Scoring system 184 may have a weighted model configured to analyze the different aspects of the of consumer profile 130. For example, based on consumer portfolio 136 and/or transaction history 132, scoring system 184 may determine that the consumer associated with consumer portfolio 136 may favor merchant A, and therefore, score offers from merchant A higher than other offers. Similarly, scoring system 184 may recognize that the consumer opened a new points account with merchant B, which was added to consumer portfolio 136. Therefore, scoring system 184 may determine that the consumer may be looking to transact more with merchant B, and present offers from merchant B.

The score of an item may be a consumer relevance value (or “CRV”), which is the relevance of a particular item to the consumer. Stated another way, the CRV is a score of how likely the consumer or user will be interested in the item and take advantage of the item being presented to them. Moreover, in various embodiments, scoring system 184 may comprise a variety of “closed loop” or internal data associated with a consumer. In various embodiments, scoring system 184 may comprise a system for tailoring marketing. Additional information about CRVs and the associated offers may be found at U.S. patent application Ser. No. 13/794,374 filed on Mar. 11, 2013 and entitled “Systems and Methods for Tailoring Marketing”, which is incorporated by reference herein in its entirety.

In various embodiments, scoring system 184 may comprise a real time analysis system that may comprise hardware and/or software capable of adjusting the relevance of an item (e.g., a scored offer and/or merchant) based upon a variety of criteria, such as one or more merchant criteria, one or more business rules, and/or the like. In various embodiments, the real time analysis system may be separate from, but in electronic communication with, and receive the variety of criteria from, scoring system 184. The real time analysis system may also be in electronic communication with, and receive information from, consumer profile 130 through scoring system 184. For example, the real time analysis system may monitor real time information associated with a consumer or user and/or merchant such as changes in merchant interest in acquiring new consumers, merchant interest in rewarding loyal consumers with merchant points, time of year (i.e., holidays), time of day, consumer location, consumer preferences (e.g., the consumer has given the offer a “thumbs down,” or the consumer's transaction history data indicated a change in preferences), the consumers recent transaction history data, and/or the like. Based on any such changes, the real time analysis system may adjust the CRVs for consumers and items of potential interest to those consumers. In various embodiments, the real time analysis system may comprise a system, such as a system described in U.S. patent application Ser. No. 13/794,374, filed Mar. 11, 2013, and entitled “Systems and Methods for Tailoring Marketing.”

Based on transaction history 132 and CRV associated with various items or merchant points, scoring system 184 may recommend a transaction to a consumer by displaying an item on web client 120. For example, the item may comprise a suggestion to the consumer to exchange a first merchant's points for a second merchant's points based on factors such as the consumer's nonuse of the first merchant points, and the consumer's frequent accumulation and/or use of the second merchant points. As another example, the item may comprise a suggestion to redeem merchant points for a certain product based on the consumer's transaction history 132, which may include exchanging merchant points as a step in obtaining the product.

In various embodiments, in order to utilize system 100 and/or exchange engine 150, consumers and/or merchants may be required to on-board or register with, and/or log into, an account for exchange engine 150 through a web client 120. In order to facilitate an exchange of one merchant's points for another merchant's points, exchange engine 150 may be able to receive and/or retrieve merchant points from consumer portfolio 136, and/or receive funds and/or merchant points from merchant point programs 172-176. Merchants may allow exchange engine 150 access to their respective points programs (e.g., merchant points programs 172-176), via an application programming interface (API), for example, through which exchange engine 150 may communicate with the associated merchants. Similarly, consumers may register and/or create a consumer profile 130 with exchange engine 150 and link to each merchant's points program of which the consumer is part (via an API, for example). Merchant points programs of merchants with which the consumer transacts may prompt the consumer to register with system 100 and/or exchange engine 150. Therefore, exchange engine 150 may be in electronic communication with consumer profile 130 and/or merchant points programs 172-176 with electronic channels to transmit points and/or funds (via APIs, for example). In various embodiments, in order for a consumer to exchange merchant points of one merchant to those of another, the consumer may need to have a relationship with each merchant involved in the transaction (have registered with the involved merchants to receive respective merchant points).

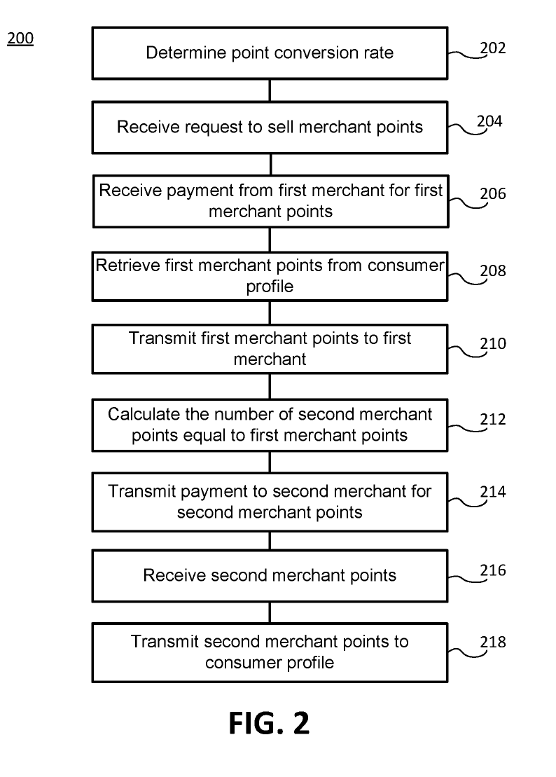

Referring now to FIGS. 2-4 the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-4, but also to the various system components as described above with reference to FIG. 1.

With combined reference to FIGS. 1 and 2, in accordance various embodiments, a method 200 for exchanging merchant points using system 100 is depicted. In various embodiments, exchange engine 150 may determine a conversion rate (step 202) between two or more merchants' points, and/or between each merchant's points and a standard point. To determine the value of a merchant's points (e.g., the value of merchant A points offered through merchant A points program 172), exchange engine 150 may retrieve and/or receive information (e.g., inputs 110) from various sources such as social media, news sources, stock exchanges, market information providers, merchant point programs 172-176, consumer profiles (e.g., consumer profile 130), or any other suitable source.

As discussed herein, inputs 110 for determining a point conversion rate may be various factors, including demand for a merchant's points, merchant point value relative to a national currency (i.e., cash), a public rating or public opinion of the merchant, a public following of the merchant, or the like. Greater demand for or usage of a merchant's points, the fewer merchant points required to buy items, positive publicity and a good public opinion, and/or a large public following of a merchant may cause exchange engine 150 to determine that a merchant having one or more of these characteristics should have greater value given to the associated merchant points. On the other hand, little or no demand for or usage of a merchant's points, larger numbers of merchant points required to purchase products, negative publicity or public opinion, and/or little or no public following may indicate to exchange engine 150 that such a merchant's points should be valued less. The valuation of merchant points may be relative to another merchant's points or a standard point to which all merchant points are valued.

In various embodiments, as discussed herein, a standard point may be a point unassociated with any merchant, but may be a standard to which all other merchant points are relatively valued. For example, exchange engine 150 may determine a value for merchant A points relative to standard points (i.e., a conversion rate between merchant A points and standard points). Such a conversion rate may be determined by any of the factors discussed above. Additionally, the standard point may be a value based on another measure such as a national currency (e.g., the U.S. dollar), so the amount of merchant points it takes to purchase a product may help determine the conversion rate between merchant points and the standard points, along with any other category of input 110. Determining conversion rates between merchant points and standard points may allow a consumer to exchange merchant points from multiple merchants in order to receive merchant points from a desired merchant. Conversion rates for merchant points associated with each merchant points program may be stored in exchange engine 150.

In various embodiments, exchange engine 150 may determine a conversion rate for each merchant, and the associated merchant points, that has registered with system 100 and/or exchange engine 150. Additionally, exchange engine 150 may receive and/or retrieve consumer information from any consumer registered with exchange engine 150 by accessing consumer profile 130 and transaction history 132, consumer portfolio 136, and/or any other information available within consumer profile 130.

In various embodiments, a consumer who has registered or created a consumer profile 130 with system 100 and/or exchange engine 150 may wish to exchange an amount of one (or more) merchant's points comprised in the consumer's consumer portfolio 136 for another merchant's points. Therefore, the consumer may request an exchange through consumer profile 130 via a user interface on web client 120. In doing so, the consumer is requesting to sell the merchant points the consumer does not want in exchange for desired merchant points. Exchange engine 150 may receive the request to sell merchant points (step 204), for example, merchant A points, from the consumer through consumer profile 130. In various embodiments, exchange engine 150 may communicate with the associated merchant (merchant A), and offer the transaction to merchant A. Exchange engine 150 may calculate a monetary amount associated with the merchant A points to be sold by the consumer based on a monetary conversion rate between merchant A points and cash (e.g., the U.S. dollar), which may be a dollar value per merchant point, for example. Based on the monetary conversion rate for merchant A points, exchange engine 150 may calculate the price for merchant A to purchase the amount of merchant A points to be exchanged by the consumer.

Merchant A may accept the transaction, or in various embodiments, by being registered with exchange engine 150, merchant A may automatically accept the transaction. Exchange engine 150 may receive payment from merchant A for the merchant A points (step 206). Exchange engine 150 may retrieve merchant A points from consumer profile 130 (step 208). In various embodiments, exchange engine 150 may store merchant points owned by consumers registered with exchange engine 150. In such embodiments, exchange engine 150 may retrieve and/or access the merchant points to be exchanged. Exchange engine 150 may transmit the merchant A points to merchant A (step 210) (e.g., merchant A points program 172) in response to receiving payment from merchant A.

Exchange engine 150 may calculate the number of the desired merchant points (for example, merchant B points) that are equal to the exchanged merchant A points (step 212) based on the conversion rate between merchant A points and merchant B points. The conversion rate applied by exchange engine 150 may be calculated by exchange engine 150 by analyzing any of the factors discussed herein. The conversion rate used may be a direct conversion rate between merchant A points and merchant B points, or in various embodiments, exchange engine 150 may utilize a standard point conversion rate. For example, exchange engine 150 may convert the merchant A points to be exchanged into standard points based on a standard conversion rate between merchant A points and standard points, and subsequently convert the resulting standard points to merchant B points based on a standard conversion rate between merchant B points and standard points. In various embodiments, exchange engine 150 may use a monetary conversion rate associated with merchant B points (relative to the U.S. dollar, for example) to calculate the number to merchant B points equal to the exchanged merchant A points. For example, if the merchant A points were valued by exchange engine 150 at $100, exchange engine 150 could convert the $100 into merchant B points based on the monetary conversion rate associated with merchant B points.

In various embodiments, merchant B may issue the number of merchant B points that exchange engine 150 calculated is equal to the exchanged merchant A points. Exchange engine 150 may transmit payment for the merchant B points to merchant B points program 174 (step 214). Exchange engine 150 may receive the merchant B points from merchant B points program 174 (step 216). Exchange engine 150 may transmit the received merchant B points to consumer portfolio 136 in consumer profile 130 (step 218).

Method 200 utilizing system 100, in the illustrative example with merchant A and merchant B, allows the consumer to exchange merchant A points, which the consumer may not use, for merchant B points, which may be more practical for the consumer to have (because the consumer shops at merchant B more often, or merchant B has the products the consumer likes, etc.). Additionally, merchant A was able to obtain its outstanding merchant A points from the consumer, and therefore, remove the associated liability from their accounting books, while merchant B acquires a customer in the consumer obtaining merchant B points.

As discussed above, in various embodiments, the merchant A points used in the example above may be a gift card from merchant A, which a consumer may exchange for merchant B points, cash, standard points (for example, if the consumer is undecided about which merchant from which she would like to obtain merchant points). A gift card may be given a monetary value per dollar of the gift card by exchange engine 150 (based on a monetary conversion rate), and then converted to standard points or any desired merchant points. Likewise, a consumer may purchase merchant points using cash, wherein the cash value would be added to consumer portfolio 136 to be exchanged by exchange engine 150 in a similar fashion.

In various embodiments, exchange engine 150 may keep some monetary value as a fee for conducting and/or brokering a transaction. For example, exchange engine 150 may charge a per-transaction fee, a transaction fee based on the volume of points exchanged, and/or exchange engine 150 may charge one of the merchants and/or consumers in the transaction a fee, which may be taken out of the points exchanged, or directly paid by the merchant and/or consumer. Therefore, the merchant points amounts exchanged between merchants, after exchange engine 150 takes a fee, may not be exactly equal.

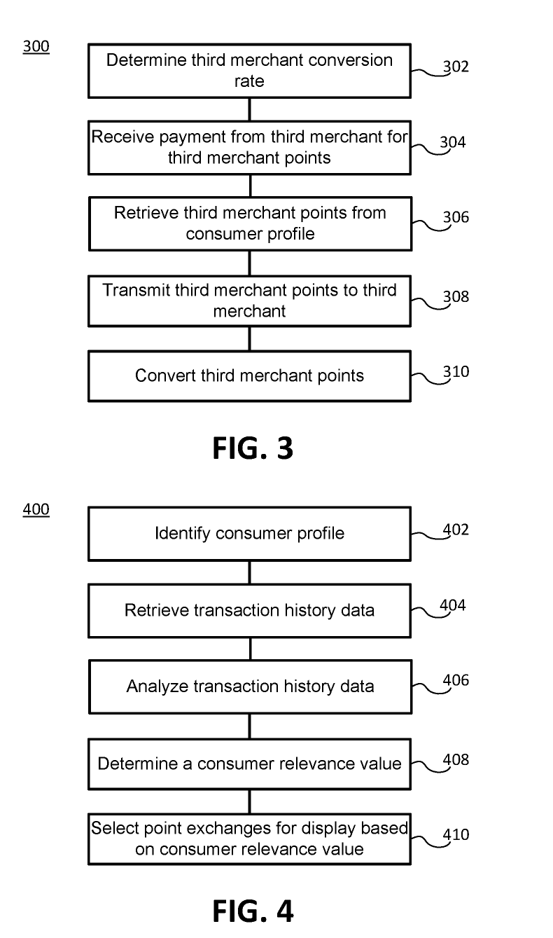

In accordance with various embodiments, FIG. 3 depicts a method 300 for exchanging more than one type of merchant points. For example, a consumer may wish to exchange merchant A points and merchant C points (and any additional merchant points from other merchants, cash, gift cards, or other forms of currency) for merchant B points. Therefore, exchange engine 150 may determine a merchant C conversion rate (step 302). Exchange engine 150 may communicate with merchant C points program 176 and offer the transaction. Merchant C may accept, or automatically accept, the transaction through merchant C points program, and transmit payment to exchange engine for the merchant C points to be exchanged by the consumer. Exchange engine 150 may receive the payment from merchant C for the merchant C points (step 304). Exchange engine 150 may retrieve and/or receive the merchant C points to be exchanged from consumer profile 130 and/or consumer portfolio 136 (step 306). Exchange engine 150 may transmit the merchant C points to merchant C points program 176 (step 308) in exchange for the payment from merchant C.

Exchange engine 150 may convert the merchant C points (step 310) based on the merchant C conversion rate. In various embodiments, the merchant C conversion rate may be a direct conversion rate between merchant C points and merchant B points, such that the merchant B points resulting from the conversions of merchant A points and merchant C points may be added together to get the equivalent number of merchant B points, or the merchant C conversion rate may be a standard conversion rate for converting merchant C points to standard points. With an standard conversion rate, exchange engine 150 may convert merchant A points to standard points using the merchant A standard point conversion rate, and convert merchant C points using a merchant C standard point conversion rate, and add the resulting standard points together from the merchant A and merchant C conversions. Subsequently, exchange engine 150 may calculate the number of merchant B points equal to the number of standard points resulting from the merchant A points and merchant B points, based on a merchant B standard point conversion rate.

Exchange engine 150 may transmit payment to merchant B points program 174 to issue the merchant B points equivalent to the exchanged merchant C points, and merchant B points program 174 may issue the merchant B points and transmit them to exchange engine 150. Exchange engine 150 may transmit the merchant B points to consumer profile 130, which may store the merchant B points in consumer portfolio 136.

In various embodiments, system 100 may offer items (e.g., point redemption and/or exchange suggestions) to the consumers registered with system 100 based on the consumers' transaction history, including spending and point-usage habits, or the like. FIG. 4 depicts a method 400 for scoring items (e.g., point exchanges) to consumers using system 100. With combined reference to FIGS. 1 and 4, scoring system 184 may identify a consumer profile 130 (step 402) associated with a consumer, and the consumer portfolio 136 and merchant points from different merchants within. As discussed herein, in various embodiments, in order to use system 100, the consumer must have registered with and/or logged into system 100 and/or exchange engine 150. As a result of the consumer logging in, exchange engine 150 may identify consumer profile 130 (step 402) associated with the web client 120 user (i.e., the consumer). In response to identifying consumer profile 130, transaction history 132 from consumer profile 130 may be retrieved (step 404). Scoring system 184, via a collaborative scoring algorithm, may analyze transaction history 132 (step 406), looking for trends in transaction and/or point exchanging habits, as discussed herein. Based on the analysis of transaction history 132, scoring system 184 may determine a CRV (step 408) for at least one item (such as a product offered by a merchant in exchange for merchant points, or exchanging merchant points from one merchant, which the consumer may not prefer, for the merchant points of another merchant, which transaction history 132 may reflect the consumer may prefer). The CRV may be reflective of the relevance of one item, or a plurality or list of items to a consumer profile.

In various embodiments, exchange engine 150 may receive the CRVs or lists of CRVs for items associated merchant points programs (e.g., merchant points programs 172-176) in system 100 and in communication with exchange engine 150. In various embodiments, exchange engine 150 may select items (e.g., offered point exchanges) for display, based on the CRVs (step 410), in consumer profile 130 via web client 120. For example, exchange engine 150 may preferentially select to only show items having a high CRV for a particular consumer. In various embodiments, the consumer may elect to only have exchange engine 150 show items in information boxes having high CRVs, or for preferred products and/or merchants (i.e., the items “recommended for you”). The consumer may select an offered item, and exchange engine 150, in response, may initiate the merchant points exchange associated with the item, as discussed herein.

The disclosure and claims do not describe only a particular outcome of exchanging merchant points, but the disclosure and claims include specific rules for exchanging merchant points and that render information into a specific format that is then used and applied to create the desired results of merchant points exchange, as set forth in McRO, Inc. v. Bandai Namco Games America Inc. (Fed. Cir. case number 15-1080, Sep. 13, 2016). In other words, the outcome of exchanging merchant points can be performed by many different types of rules and combinations of rules, and this disclosure includes various embodiments with specific rules. While the absence of complete preemption may not guarantee that a claim is eligible, the disclosure does not sufficiently preempt the field of exchanging merchant points at all. The disclosure acts to narrow, confine, and otherwise tie down the disclosure so as not to cover the general abstract idea of just exchanging merchant points. Significantly, other systems and methods exist for trading in merchant points for other forms of redeemable points, so it would be inappropriate to assert that the claimed invention preempts the field or monopolizes the basic tools for exchanging merchant points. In other words, the disclosure will not prevent others from exchanging merchant points, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber when their computer (e.g., web client 120) is offline. The system may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information (e.g., merchant points in consumer portfolio 136) of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link (e.g., for an item recommended via scoring system 184 and/or notification system 180) is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) merchant points and (ii) a merchant, consumer portfolio, and/or an item (e.g., offer, reward, discount). Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The system or any components may integrate with system integration technology such as, for example, the ALEXA system developed by AMAZON. Alexa is a cloud-based voice service that can help you with tasks, entertainment, general information and more. All Amazon Alexa devices, such as the Amazon Echo, Amazon Dot, Amazon Tap and Amazon Fire TV, have access to the Alexa Voice Service. The system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The system may allow the user to access information about eligible accounts linked to an online account across all Alexa-enabled devices.

The customer may be identified as a customer of interest to a merchant based on the customer's transaction history 132, which may including transactions at the merchant (e.g., using merchant points), types of transactions, type of transaction account, frequency of transactions, number of transactions, lack of transactions, timing of transactions, transaction history at other merchants (e.g., using merchant points for other merchants), demographic information, personal information (e.g., gender, race, religion), social media or any other online information, potential for transacting with the merchant and/or any other factors.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction data. The ROC may be a unique identifier associated with a transaction. Record of Charge (ROC) data includes important information and enhanced data. For example, a ROC may contain details such as location, merchant name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE® TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER, JAVA Virtual Machine running on LINUX or WINDOWS).

Practitioners will appreciate that web client 120 may or may not be in direct contact with an application server. For example, web client 120 may access the services of an application server through another server and/or hardware component, which may have a direct or indirect connection to an Internet server. For example, web client 120 may communicate with an application server via a load balancer. In various embodiments, access is through a network or the Internet through a commercially-available web-browser software package.

As those skilled in the art will appreciate, web client 120 includes an operating system (e.g., WINDOWS®/CE/Mobile, OS2, UNIX®, LINUX®, SOLARIS®, MacOS, etc.) as well as various conventional support software and drivers typically associated with computers. Web client 120 may include any suitable personal computer, network computer, workstation, personal digital assistant, cellular phone, smart phone, minicomputer, mainframe or the like. Web client 120 can be in a home or business environment with access to a network. In various embodiments, access is through a network or the Internet through a commercially available web-browser software package. Web client 120 may implement security protocols such as Secure Sockets Layer (SSL) and Transport Layer Security (TLS). Web client 120 may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, or any other suitable database product. Moreover, the databases may be organized in any suitable manner, for example, as data tables or lookup tables. Each record may be a single file, a series of files, a linked series of data fields or any other data structure.

The blockchain structure may include a distributed database that maintains a growing list of data records. The blockchain may provide enhanced security because each block may hold individual transactions and the results of any blockchain executables. Each block may contain a timestamp and a link to a previous block. Blocks may be linked because each block may include the hash of the prior block in the blockchain. The linked blocks form a chain, with only one successor block allowed to link to one other predecessor block.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of web client 120 may be further equipped with an Internet browser connected to the Internet or an intranet using standard dial-up, cable, DSL or any other Internet protocol known in the art. Transactions originating at web client 120 may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a My SQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as Npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As used herein, the term “end user”, “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to a “party” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

What is claimed is:

1. A method, comprising:
determining, by a processor, a point conversion rate between a first merchant point value associated with a first merchant point and a second merchant point value associated with a second merchant point,
wherein the first merchant point is redeemable with a first merchant, and the second merchant point is redeemable with a second merchant;
receiving, by the processor, a request from a consumer to sell an exchanged point amount,
wherein the exchanged point amount comprises a first merchant point amount,
wherein the first merchant point amount comprises the first merchant point;
receiving, by the processor, a first payment from the first merchant for the first merchant point amount;
retrieving, by the processor, the first merchant point amount from a consumer profile;
transmitting, by the processor, the first merchant point amount to the first merchant;
calculating, by the processor, a second merchant point amount, wherein the second merchant point amount comprises the second merchant point, equal to the first merchant point amount based the first conversion rate;
transmitting, by the processor, a second payment to the second merchant to purchase the second merchant point amount from the second merchant;
receiving, by the processor, the second merchant point amount from the second merchant; and
transmitting, by the processor, the second merchant point amount to the consumer profile.

2. The method of claim 1, wherein the determining the point conversion rate comprises:
determining, by the processor, a first standard conversion rate between the first merchant point value and a standard point value associated with a standard point; and
calculating, by the processor, a second standard conversion rate between the second merchant point value and the standard point value.

3. The method of claim 2, wherein the calculating the second merchant point amount equal to the first merchant point amount comprises:
converting, by the processor, the first merchant point amount to a first standard point amount comprising the standard point based on the first standard conversion rate,
wherein the first standard point amount is comprised in an exchanged standard point amount; and
converting, by the processor, the exchanged standard point amount to the second merchant point amount based on the second standard conversion rate.

4. The method of claim 3, further comprising:
determining, by the processor, a first cash value associated with the first merchant point; and
calculating, by the processor, the first payment for the first merchant point amount based on the first cash value.

5. The method of claim 3, further comprising:
determining, by the processor, a third standard conversion rate between a third merchant point value associated with a third merchant point and the standard point value, wherein the third merchant point is redeemable with a third merchant,
wherein the exchanged point amount comprises a third merchant point amount comprising the third merchant point;
receiving, by the processor, a third payment from the third merchant for the third merchant point amount;
retrieving, by the processor, the third merchant point amount from the consumer profile;
transmitting, by the processor, the third merchant point amount to the third merchant; and
converting, by the processor, the third merchant point amount to a third standard point amount comprising the standard point, wherein the third standard point amount is comprised in the exchanged standard point amount.

6. The method of claim 2, wherein at least one of the point conversion rate or the first standard conversion rate is based off of at least one of a demand for the first merchant point, a first merchant point currency value reflected by a currency conversion rate between the first merchant point value and a national currency, a public rating of the first merchant, or a public following.

7. The method of claim 6, further comprising adjusting, by the processor, at least one of the point conversion rate or the first standard conversion rate based on a change in at least one of the demand for the first merchant point, the first merchant point currency value, the public rating of the first merchant, or the public following.

8. The method of claim 1, further comprising displaying, by the processor, an offer to the consumer to exchange the first merchant point amount for the second merchant point amount.

9. An article of manufacture including a non-transitory, tangible computer readable storage medium having instructions stored thereon that, in response to execution by a processor of a processing machine, cause the processor to perform operations comprising:
determining, by the processor, a point conversion rate between a first merchant point value associated with a first merchant point and a second merchant point value associated with a second merchant point,
wherein the first merchant point is redeemable with a first merchant, and the second merchant point is redeemable with a second merchant;
receiving, by the processor, a request from a consumer to sell an exchanged point amount,
wherein the exchanged point amount comprises a first merchant point amount,
wherein the first merchant point amount comprises the first merchant point;
receiving, by the processor, a first payment from the first merchant for the first merchant point amount;
retrieving, by the processor, the first merchant point amount from a consumer profile;
transmitting, by the processor, the first merchant point amount to the first merchant;
calculating, by the processor, a second merchant point amount, wherein the second merchant point amount comprises the second merchant point, equal to the first merchant point amount based the first conversion rate;
transmitting, by the processor, a second payment to the second merchant to purchase the second merchant point amount from the second merchant;
receiving, by the processor, the second merchant point amount from the second merchant; and
transmitting, by the processor, the second merchant point amount to the consumer profile.

10. The article of claim 9, wherein the determining the point conversion rate comprises:
determining, by the processor, a first standard conversion rate between the first merchant point value and a standard point value associated with a standard point; and
calculating, by the processor, a second standard conversion rate between the second merchant point value and the standard point value.

11. The article of claim 10, wherein the calculating the second merchant point amount equal to the first merchant point amount comprises:
converting, by the processor, the first merchant point amount to a first standard point amount comprising the standard point based on the first standard conversion rate,
wherein the first standard point amount is comprised in an exchanged standard point amount; and
converting, by the processor, the exchanged standard point amount to the second merchant point amount based on the second standard conversion rate.

12. The article of claim 11, wherein the operations further comprise:
determining, by the processor, a first cash value associated with the first merchant point; and
calculating, by the processor, the first payment for the first merchant point amount based on the first cash value.

13. The article of claim 11, wherein the operations further comprise:
determining, by the processor, a third standard conversion rate between a third merchant point value associated with a third merchant point and the standard point value, wherein the third merchant point is redeemable with a third merchant,
wherein the exchanged point amount comprises a third merchant point amount comprising the third merchant point;
receiving, by the processor, a third payment from the third merchant for the third merchant point amount;
retrieving, by the processor, the third merchant point amount from the consumer profile;
transmitting, by the processor, the third merchant point amount to the third merchant; and
converting, by the processor, the third merchant point amount to a third standard point amount comprising the standard point, wherein the third standard point amount is comprised in the exchanged standard point amount.

14. The article of claim 10, wherein at least one of the point conversion rate or the first standard conversion rate is based off of at least one of a demand for the first merchant point, a first merchant point currency value reflected by a currency conversion rate between the first merchant point value and a national currency, a public rating of the first merchant, or a public following.

15. The article of claim 14, wherein the operations further comprise adjusting, by the processor, at least one of the point conversion rate or the first standard conversion rate based on a change in at least one of the demand for the first merchant point, the first merchant point currency value, the public rating of the first merchant, or the public following.

16. The article of claim 9, wherein the operations further comprise displaying, by the processor, an offer to the consumer to exchange the first merchant point amount for the second merchant point amount.

17. A system comprising:
a processor of a processing machine,
a tangible, non-transitory memory configured to communicate with the processor,
the tangible, non-transitory memory having instructions stored thereon that, in response to execution by the processor, cause the processor to perform operations comprising:
determining, by the processor, a point conversion rate between a first merchant point value associated with a first merchant point and a second merchant point value associated with a second merchant point,
wherein the first merchant point is redeemable with a first merchant, and the second merchant point is redeemable with a second merchant;
receiving, by the processor, a request from a consumer to sell an exchanged point amount,
wherein the exchanged point amount comprises a first merchant point amount,
wherein the first merchant point amount comprises the first merchant point;
receiving, by the processor, a first payment from the first merchant for the first merchant point amount;
retrieving, by the processor, the first merchant point amount from a consumer profile;
transmitting, by the processor, the first merchant point amount to the first merchant;
calculating, by the processor, a second merchant point amount, wherein the second merchant point amount comprises the second merchant point, equal to the first merchant point amount based the first conversion rate;
transmitting, by the processor, a second payment to the second merchant to purchase the second merchant point amount from the second merchant;
receiving, by the processor, the second merchant point amount from the second merchant; and
transmitting, by the processor, the second merchant point amount to the consumer profile.

18. The system of claim 17, wherein the determining the point conversion rate comprises:
determining, by the processor, a first standard conversion rate between the first merchant point value and a standard point value associated with a standard point; and
calculating, by the processor, a second standard conversion rate between the second merchant point value and the standard point value.

19. The system of claim 18, wherein the calculating the second merchant point amount equal to the first merchant point amount comprises:
converting, by the processor, the first merchant point amount to a first standard point amount comprising the standard point based on the first standard conversion rate,
wherein the first standard point amount is comprised in an exchanged standard point amount; and
converting, by the processor, the exchanged standard point amount to the second merchant point amount based on the second standard conversion rate.

20. The system of claim 19, wherein the operations further comprise:
determining, by the processor, a third standard conversion rate between a third merchant point value associated with a third merchant point and the standard point value, wherein the third merchant point is redeemable with a third merchant,
wherein the exchanged point amount comprises a third merchant point amount comprising the third merchant point;
receiving, by the processor, a third payment from the third merchant for the third merchant point amount;
retrieving, by the processor, the third merchant point amount from the consumer profile;
transmitting, by the processor, the third merchant point amount to the third merchant; and
converting, by the processor, the third merchant point amount to a third standard point amount comprising the standard point, wherein the third standard point amount is comprised in the exchanged standard point amount.
